(19) United States
(12) Patent Application Publication
(10) Pub. No.: US 2021/0361106 A1
(43) Pub. Date: Nov. 25, 2021

(54) Manual Fruit, Vegetable, or Nut Squeezer

(71) Applicants: Renee Maverick, West Palm Beach, FL (US); Alexander Maverick, West Palm Beach, FL (US)

(72) Inventors: Renee Maverick, West Palm Beach, FL (US); Alexander Maverick, West Palm Beach, FL (US)

(21) Appl. No.: 17/302,928

(22) Filed: May 17, 2021

Related U.S. Application Data
(60) Provisional application No. 63/029,155, filed on May 22, 2020.
(60) Provisional application No. 63/030,383, filed on May 27, 2020.
(60) Provisional application No. 63/087,979, filed on Oct. 6, 2020.

(51) Int. Cl. A47J 19/02; B30B 9/10; A47J 19/06; A47J 19/00; A47J 43/26

(52) U.S. Cl. CPC A47J 19/02; B30B 9/10; A47J 43/26; A47J 19/005; A47J 19/06

(57) ABSTRACT

A side-squeezing squeezer including a hinge, a first presser connected to the hinge, a second presser connected to the hinge opposite of the first presser, and a support positioned between the first presser and the second presser and configured to hold a foodstuff in place. The first and second pressers may be configured to squeeze the foodstuff using lever action from the side.

### BACKGROUND

### Field of the Invention

The present invention relates generally to food product systems, and more specifically, to a manual fruit, vegetable, or nut squeezer.

### Description of Related Art

Various issues relating to manual fruit, vegetable, or nut squeezers are known in the art. Accordingly, there is a need in the art for an improved manual fruit, vegetable, or nut squeezer.

It is desirable to have a manual squeezer that causes less strain in the fingers, hand, wrist, and/or arm when squeezing the food item. Furthermore, it is desirable to have a manual squeezer that more effectively prevents leakage of juice, pulp, and seeds to unintended places. Still, further, it is desirable to have a manual squeezer that has enhanced stability as it is rested on top of a separate container. Aspects of the present invention may provide a manual squeezer that requires less force in the fingers, hand, wrist, and/or arm when squeezing the fruit (e.g., a citrus fruit such as a citron, lemon, lime, orange, or grapefruit) or vegetable (e.g., a tomato or cucumber) or nut (e.g., almonds, walnuts, hazelnuts, pecans, brazil nuts, or pistachios). Aspects of the present invention may additionally or alternatively provide a manual squeezer that allows less leakage of juice, pulp, and/or seeds to unintended places. Aspects of the present invention may also additionally or alternatively provide enhanced stability as it is placed on top of a separate container.

### SUMMARY OF THE INVENTION

In light of the above, embodiments of the invention may directed to a side-squeezing squeezer comprising a hinge, a first presser connected to the hinge, a second presser connected to the hinge opposite of the first presser, and a support positioned between the first presser and the second presser and configured to hold a foodstuff in place. The first and second pressers may configured to squeeze the foodstuff using lever action from the side.

In some embodiments, the squeezer may further comprise a first handle extending from the first presser and a second handle extending from the second presser. In further embodiments, at least one of the first handle and the second handle may be hollow.

In some embodiments, the support may include a support surface that is configured to support the foodstuff. In some embodiments, the support may include one or more holes configured to provide straining of liquid expelled from the foodstuff. In some embodiments, the support may include one or more walls extending around at least a portion of a periphery of the support. In further embodiments, the squeezer may further comprise one or more openings extending through the second presser, the one or more openings configured to allow for a wall of the one or more walls to pass through the one or more openings when the squeezer is pressed together.

In some embodiments, at least one of the first presser and the second presser may include a textured section. In some embodiments, the squeezer may further comprise a bar attached to the support and configured to extend away from the hinge to provide support for the squeezer atop of a container. In further embodiments, the squeezer may further comprise a bar container. The bar may be retractable and configured to be selectively extended from or retracted into the bar container.

In some embodiments, the squeezer may further comprise a funnel member attached to the support, the funnel member configured to direct expelled liquid from the foodstuff. In some embodiments, the squeezer may further comprise a flat plane created along a surface of the hinge, a surface of the first presser, and a surface of the second presser. The flat plane may allow for the squeezer to rest flat on a surface or a container. In some embodiments, the support may be collapsible. In some embodiments, at least one of the first presser and the second presser may be a blade.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric view of a manual squeezer in accordance with the present application;

FIG. 2 is a side isometric view of the manual squeezer in accordance with the present application;

FIG. 3 is a right side view of the manual squeezer of the present invention in an open position;

FIG. 4 is a left side view of the manual squeezer of the present invention;

FIG. 5 is a top view of the manual squeezer of the present invention in an open position;

FIG. 6 is a bottom view of the manual squeezer of the present invention in an open position;

FIG. 7 is a top view of a first embodiment of the handles of the manual squeezer of the present invention;

FIG. 8 is a top view of a second embodiment of the handles of the manual squeezer of the present invention;

FIG. 9 is a top view of a third embodiment of the handles of the manual squeezer of the present invention;

FIG. 10 is a top view of an embodiment of the manual squeezer of the present invention having a support that functions as a container;

FIG. 11 is a top view of an embodiment of the manual squeezer of the present invention having a support that functions as a holder;

FIG. 12 is a top view of the manual squeezer of the present invention not having an interior wall in an open position;

FIG. 13 is a bottom view of the manual squeezer of the present invention not having an interior wall in an open position;

FIG. 14 is a top view of the manual squeezer of the present invention having a squeezer holder bar in an open position;

FIG. 15 is a top view of the manual squeezer of the present invention having a squeezer holder bar in an open position;

FIG. 16 is a bottom view of the manual squeezer of the present invention having a squeezer holder bar in an open position;

FIG. 17 is a bottom view of the manual squeezer of the present invention having a squeezer holder bar in an open position;

FIG. 18 is a top view of the manual squeezer of the present invention with a collapsible support in a closed position;

FIG. 19 is a top view of the manual squeezer of the present invention with a collapsible support in a closed position;

FIG. 20 is a left side view of the manual squeezer of the present invention with a funnel member;

FIG. 21 is a bottom view of the manual squeezer of the present invention with the funnel member in an open position;

FIG. 22 is an isometric view of the manual squeezer of the present invention in an open position; and

FIG. 23 is a side isometric view of the manual squeezer of the present invention in an open position.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE INVENTION

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional squeezer systems. Specifically, the present invention provides for an improved side to side squeezer that allows for easy squeezing of the food product. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

In the following description, reference will be made to fruits, vegetables, and nuts. These items are merely examples of the types of foodstuffs that the invention may be used with. It is contemplated and included within the scope of the invention that any foodstuff or portion thereof that may positioned between the squeezing surfaces of the invention, as will be described below, may be used in conjunction with the invention, and the invention is not limited to any type or category of foodstuff.

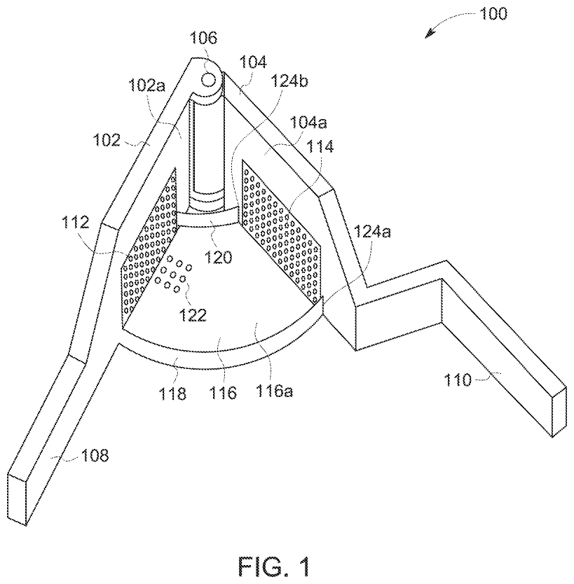

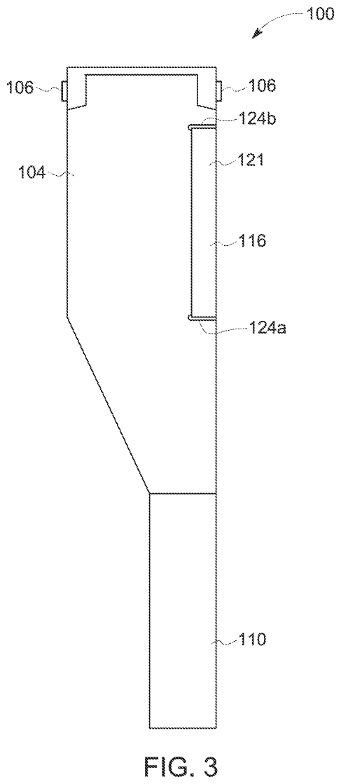

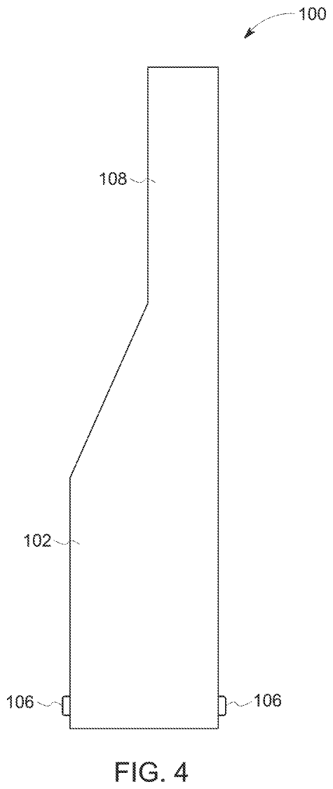

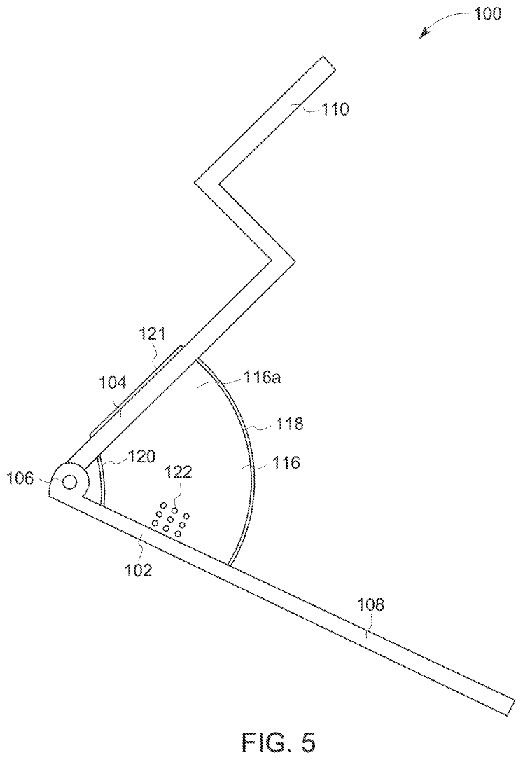

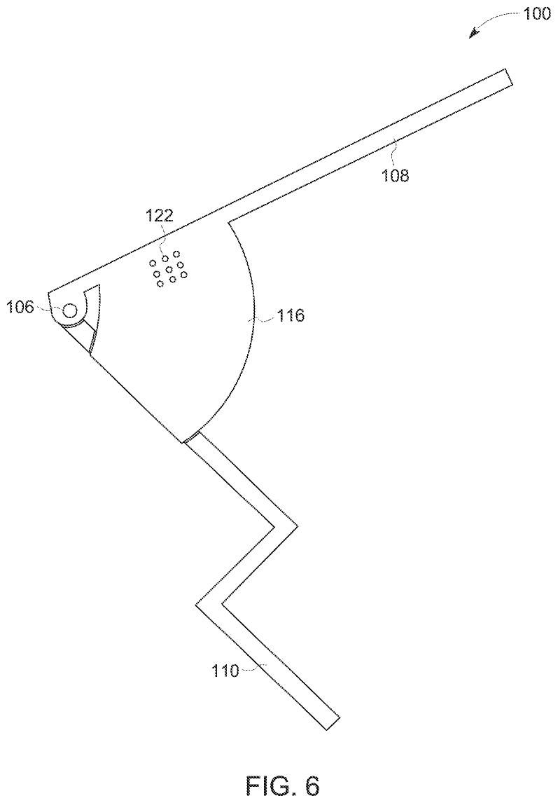

Referring now to the drawings wherein like reference characters identify corresponding or similar elements throughout the several views, FIGS. 1-7 depict various views of a manual squeezer 100 in accordance with the present application.

In some embodiments, the squeezer 100 may be configured to extract juice from a fruit (e.g., a citrus fruit such as a citron, lemon, lime, orange, or grapefruit) or a vegetable (e.g., tomato or cucumber). In some embodiments, the squeezer 100 may be used for the purpose of squeezing a whole lime that is cut in half or a whole lemon that is cut in half. In some embodiments, the squeezer 100 may be used for squeezing a fruit or vegetable that is the size of a half-cut lemon or larger. In some embodiments, the squeezer may be used for squeezing a fruit or vegetable that is the size of a half-cut lime or larger. In some embodiments, the squeezer 100 may be used to crack the shells of nuts (e.g., almonds, walnuts, hazelnuts, pecans, brazil nuts, or pistachios). In some embodiments, the squeezer 100 may be a side-squeezing squeezer. In some embodiments, a part or all of one or more components of the squeezer 100 may be made of any of various materials (e.g., including one or more of stainless steel, aluminum, silicone, and plastic). In some embodiments, substantially all of squeezer 100 may be made of aluminum. In some embodiments, substantially all of squeezer 100 may be made of stainless steel.

As shown in at least FIG. 1, in some embodiments, the squeezer 100 may include a first presser 102 and a second presser 104. As shown, the first and second pressers may be structural components that are re-configured to be utilized to press against the fruit/vegetable/nut.

In some embodiments, the first presser 102 may be a blade, and/or the second presser 104 may be a blade. In some embodiments, the first and second pressers 102 and 104 may be connected at a hinge 106, wherein the first and second pressers extend away from the hinge and are configured to pivot together via the hinge 106.

In some embodiments, the hinge 106 may be any type of hinge and may, for example and without limitation, be a pin joint, use spring action, and/or connect the first and second pressers with a flexible material. In some embodiments, the squeezer 100 may include a first handle 108 and second handle 110. In some embodiments, the first and second handles 108 and 110 may be formed integrally with the first and second pressers 102 and 104, respectively, such as is shown in at least FIG. 1. However, this is not required, and, in some alternative embodiments, the first and second handles 108 and 110 may be formed separately from but attached to the first and second pressers 102 and 104, respectively. In some embodiments, the first presser 102 may be located between the hinge 106 and the first handle 108, and the second presser 104 may be located between the hinge 106 and the second handle 110.

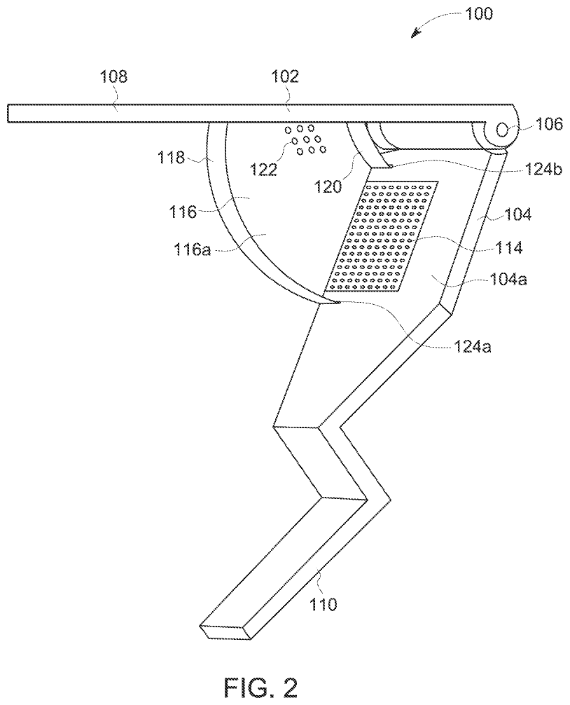

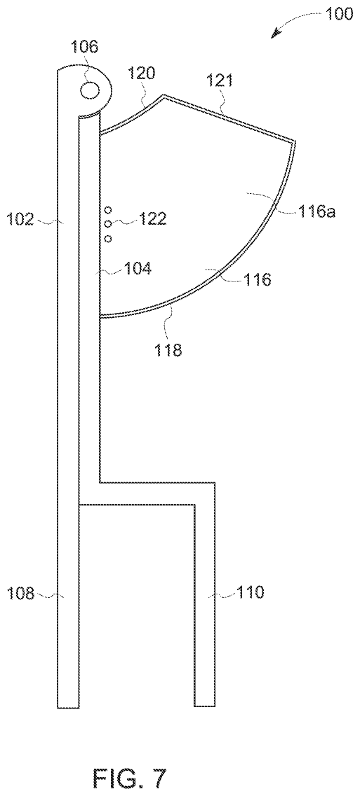

In some embodiments, the first presser 102 may include a pressing surface 102a, and the second presser 104 may include a pressing surface 104a. The pressing surfaces 102a and 104a may be configured to press against and squeeze a fruit or vegetable or nut when the first and second pressers 102 and 104 are moved from an open position, as shown in FIGS. 1-3, 5, and 6, to a closed position, as shown in FIG. 7. In some embodiments, as shown in FIGS. 1 and 2, the pressing surfaces 102a and 104a may be flat. However, this is not required, and, in some alternative embodiments, the pressing surfaces 102a and 104a may have other shapes (e.g., the shape of a cup or a rectangular shape).

In some embodiments, the first presser 102 may include one or more textured sections 112 on the pressing surface 102a of the first presser 102. In some embodiments, the second presser 104 may include one or more textured sections 114 on the pressing surface 104a of the second presser 104. In some embodiments, as shown in FIGS. 1 and 2, the textured sections 112 and 114 of the first and second pressers 102 and 104 may be formed at least at lower portions of the pressing surfaces 102a and 104a. In some alternative embodiments, the textured sections 112 and 114 may extend from the bottom to the top of the pressing surfaces 102a and 104a of the first and second pressers 102 and 104. In some embodiments, the textured sections 112 and 114 of the first and second pressers 102 and 104 may be configured to increase friction with the goal of preventing the fruit or vegetable or nut from slipping when squeezed by the pressing surfaces 102a and 104a of the first and second pressers 102 and 104. In some embodiments, the textured sections 112 and 114 may include protruding shapes and/or depressed shapes. In some embodiments, one or more of the textured sections 112 and 114 may include one or more spikes or ridges extending from the pressing surface 102a or 104a.

In some embodiments, there may be a substantially flat plane created between a bottom surface of the hinge 106, the bottom surface of the first and second pressers, and the bottom surface of the handles. This may allow the entire squeezer 100 to be rested or placed on the container in a more secure fashion (e.g., by placing the 2 handles 108 and 110 and hinge 106 area on the container rim).

In some embodiments, the squeezer 100 may include support 116 which may be configured to hold the fruit, vegetable, or nut in place. In some embodiments, the support 116 may extend from the first presser 102 (e.g., from the bottom of the first presser 102). In some embodiments, the support 116 may be located below the one or more of the first and second pressers 102 and 104. In some embodiments, the support 116 may be formed integrally with the first presser 102, or, in some alternative embodiments, the support 116 may be formed separately from the first presser 102 and attached to the first presser 102. In some embodiments, the support 116 may be formed integrally with the area of the hinge 106, or, in some alternative embodiments, the support 116 may be formed separately from the area of the hinge 106 and attached to the area of the hinge 106. In some embodiments, the support 116 (or a portion thereof) may be detachable. In some embodiments, there may be an opening between support 116 and hinge 106 that may allow liquid to be drained through such opening.

As shown, the support 116 may create an area wherein the fruit, vegetable, or nut will be placed between the first and second pressers. This may allow for the food product to rest therein and for the user to act upon the food product.

In some embodiments, the support 116 may be used as one of the means to rest or place the squeezer 100 on top of a separate container, while using and not using the squeezer 100. In some embodiments, the support 116 may have a flat or substantially flat surface that is level with the rest of the substantially flat bottom surfaces of the squeezer 100, allowing the squeezer 100 to be placed in a stable fashion on top of containers (e.g., by placing the support 116 and the 2 handles 108 and 110, all with flat bottom surfaces, on the rim of the container). In some embodiments, the location of one or more holes 122 in the strainer section of the support 116 enables the juice to be extracted properly into the container without leakage to outside the container, when the squeezer 100 is operated while being rested on top of a container.

In some embodiments, the support 116 may include a support surface 116a. The support surface 116a may be configured to support a fruit or vegetable or nut (or portion thereof) while the first and second pressers 102 and 104 are moved from an open position to a closed position to squeeze the fruit or vegetable or nut between the pressing surfaces 102a and 104a and to extract the juice from the fruit or vegetable or crack the outer shells of the nut. In some embodiments, the support surface 116a may be located close to the hinge 106 (e.g., within 1.18 inch or 3 cm from the hinge 106) so that a fruit or vegetable or nut placed on the support surface 116a would be close to the pivoting hinge 106, which would allow for the pressing surfaces 102a and 104a of the first and second pressers 102 and 104 to apply the maximum amount of force to a fruit or vegetable or nut when the first and second handles 108 and 110 are used to move the first and second pressers 102 and 104 from an open position to a closed position. However, this is not required, and, in some alternative embodiments, the support surface 116a may be located farther from the hinge 106.

In some embodiments, the support surface 116a may be perpendicular (or approximately perpendicular) to one or more of the pressing surfaces 102a and 104a. In some embodiments, the support surface 116a may be approximately perpendicular to one or more of the pressing surfaces 102a and 104a if the support surface 116a is within ±20° of a right angle from one or more of the pressing surfaces 102a and 104a. Although the support surface 116a may be flat in some embodiments, this is not required. In some alternative embodiments, the support surface 116a may include one or more depressions, dents, partially lowered regions, and/or partially raised regions (e.g., the support surface 116a may have grooves, or have angled, rounded, and/or curved shapes such as a V-shape or a U-shape).

In some embodiments, as shown in FIGS. 1, 2, and 5-7, a portion or all of the support surface 116a of the support 116 may include one or more holes 122 extending through a thickness of the support 116. In some embodiments, the one or more holes 122 may form a strainer section of the support surface 116a of the support 116. In some embodiments, the strainer section of the support surface 116a of the support 116 may be located at least in a portion of the support surface 116a that is near the pressing surface 102a of the first presser 102. In some embodiments, the strainer section of the support surface 116a of the support 116 may be configured to allow juice extracted from the fruit or vegetable pass through the one or more holes 122 (e.g., to be collected in a separate container below). In some embodiments, gravity may pull the extracted juice down through the one or more holes 122. In some embodiments, the strainer section of the support surface 116a of the support 116 may be configured to prevent seeds and/or pulp from passing through the one or more holes 122. In some embodiments, the strainer section of the support surface 116a may be constructed in the shape of a funnel, with the narrow end of the funnel extending below the support surface, to direct the extracted juice in the intended direction. In some alternative embodiments, support surface 116a may include a mesh configured to strain liquid. For example, when a citrus fruit is squeezed, the mesh may allow juice to flow through the mesh into a container placed directly below the support 116, while the pulp and seeds remain on the mesh surface.

In some embodiments, as shown in FIGS. 1-3, 5, and 7, the support 116 may include one or more walls. In some embodiments, the support 116 may include walls on all sides surrounding support surface 116a. In some embodiments, the wall(s) of the support 116 may include an exterior wall 118, an interior wall 120, and/or an end wall 121. In some embodiments, the pressing surface 102a may function as a wall for the support 116 (e.g., when support 116 is extending from the pressing surface 102a of presser 102). In some embodiments, the support 116 may have one or more walls that all extend from the support surface 116a. In some embodiments, the support 116 may have walls on all sides that all extend from the support surface 116a (e.g., exterior wall 118, interior wall 120, end wall 121, and pressing surface 102a functioning as a wall). In some embodiments, one or more of the support walls may be integrally formed with the support surface 116a. In some embodiments, all the support walls may be integrally formed with the support surface 116a (e.g., exterior wall 118, interior wall 120, end wall 121, and pressing surface 102a acting as a wall). Compared to non-integrally formed support walls, these embodiments may prevent any extraction from seeping into and/or leaking through any cracks between the support surface 106a and any non-integrally formed walls, and may allow for easier cleaning. In some embodiments, one or more of the walls 118, 120, and 121 may be perpendicular or approximately perpendicular (e.g., within ±20° of a right angle) to the support surface 116a. In some embodiments, one or more of the support walls may have a height of 0.4 inch (1 cm) or higher, in order to adequately keep the extraction from leaking beyond and above the support walls. In some alternative embodiments, one or more of the support walls may have a height of 0.2 inch (0.5 cm) or higher. In some alternative embodiments, one or more of the support walls may have a height of 0.1 inch (0.25 cm) or higher. In some alternative embodiments, one or more of the support walls may have a height of 0.04 inch (0.1 cm) or higher. In some embodiments, the number of walls surrounding the support surface 116a may correspond to the number of sides of the support surface 116a. In other words, if the support surface 116a has 3, 4, 5, or 6 sides, the support 116 may have 3, 4, 5, or 6 walls respectively. In some embodiments, the walls of the support 116 may be configured to keep the fruit or vegetable or nut on the support surface 116a of the support 116. In some embodiments, the walls of the support 116 may be additionally or alternatively configured to keep juice, pulp, and/or seeds extracted from the fruit or vegetable, or the nut meat or shells from the nut, from leaking off the edges of the support surface 116a of the support 116 (e.g., so that the juice instead falls through the one or more holes 122 in the support surface 116a and the pulp and/or seeds stay on the support surface 116a). In some embodiments, one or more of the support walls (e.g., support wall 118, 120 and/or 121) may contain a spout through which the extraction is released. The spout may be in various forms, including a projecting tube, a lip or an indentation. In some embodiments, such spout may contain a strainer or a filter to strain liquid (e.g., so that only the juice is released from the squeezer and the pulp and seeds remain on the squeezer). In some embodiments, the support 116 may have one or more walls, and the first presser 102 and/or the second presser 104 may have one or more openings (e.g., slits or slots) at the bottom to allow one or more support walls to pass through as the first presser 102 and second presser 104 are moved. In some embodiments, the second presser 104 may include one or more openings (e.g., slits or slots) at the bottom to allow the walls to pass through as the first and second pressers 102 and 104 are pivotally moved relative to each other. For example, as shown in FIGS. 1-3, the second presser 104 may include an exterior opening 124a to accommodate the exterior wall 118 and/or an interior opening 124b to accommodate the interior wall 120. In some embodiments, the first and second pressers 102 and 104 may both include one or more openings (e.g., slits or slots) at the bottom to allow one or more walls to pass through as the first and second pressers 102 and 104 are pivotally moved relative to each other. For example, if the support 116 is attached to the area of the hinge 106 and has walls approximately perpendicular to the pressing surfaces 102a and 104a, the first and second pressers 102 and 104 may both be pivotally moved as the support walls pass through the respective walls at the bottom of the first and second pressers 102 and 104. In some embodiments, one or more of the exterior and interior walls 118 and 120 may be curved so that exterior wall 118 may pass through opening 124a and interior wall 120 may pass through opening 124b when first and second pressers 102 and 104 are pivotally pressed together to squeeze the fruit or vegetable or nut. In some embodiments in which the walls are curved, the corresponding sides (e.g., edges) of the support 116 may also be curved to match the curves of the walls.

In some embodiments, the support surface 116a of the support 116 may be just below the second presser 104 such that the exterior and interior walls 118 and 120 pass through the openings 124a and 124b, respectively. However, this is not required, and, in some alternative embodiments, the support 116 may be lower such that a gap exists between the support surface 116a and the second presser 104 and the exterior and interior walls 118 and 120 are just below the second presser 104. In this case, the second presser 104 may not include one or more openings (e.g., openings 124a and 124b) to accommodate one or more walls of the support 116 because the exterior and interior walls 118 and 120 are able to pass below the second presser 104. In these embodiments, one or more of the exterior and interior walls 118 and 120 may be perpendicular or approximately perpendicular (e.g., within ±20° of a right angle) to one or more of the pressing surfaces 102a and 104a of the first and second pressers 102 and 104. In some embodiments with the lower support 116, the support 116 may include walls on all sides of the support 116, without pressing surface 102a serving as one of the walls. In these embodiments, the shape of the support 116 with walls can be any shape including a round, square, or rectangular shape, since the walls do not pass through any slits.

Although the support 116 is illustrated in FIGS. 1-3, 5, and 7 with one or more walls 118, 120, and 121, the walls are not necessary. In some alternative embodiments, the support 116 may not include one or more of the walls 118, 120, and 121. For example, in some alternative embodiments, the support 116 may have no wall 118, 120, or 121, in which case the second presser 104 may not include the one or more openings (e.g., openings 124a and 124b) to accommodate one or more walls of the support 116.

In some alternative embodiments, the support surface 116a of the support 116 may not be located below the second presser 104 and may instead be located between the top and bottom of the pressing surface 104a of the second presser 104. In these alternative embodiments, the pressing surface 104a of the second presser 104 may include an opening (e.g., a slot) to accommodate the support surface 116a and allow the support surface 116a to pass through the pressing surface 104a as the first and second pressers 102 and 104 are moved between open and closed positions. In some embodiments, the opening in the pressing surface 104a of the second presser 104 that accommodates the support surface 116a may be in addition to (and may connect) any openings (e.g., openings 124a and 124b) of the second presser 104 that accommodate one or more walls of the support 116. In some embodiments, the opening of the second presser 104 to accommodate the support surface 116a may have a shape that corresponds to the shape of the support surface 116a (e.g., a straight opening for a flat support surface 116a, a curved opening for a curved support surface 116a, or a V-shaped opening for a V-shaped support surface 116a).

In some embodiments, the bottom surfaces of the first presser 102 and the first handle 108 from the hinge 106 to the end of the first handle 108 may be flat or substantially flat, and the bottom surfaces of the second presser 104 and the second handle 110 from the hinge 106 to the end of the second handle 110 may be flat or substantially flat. In these embodiments, the first and second pressers 102 and 104 and the first and second handles 108 and 110 may be rested or placed on the rim of the receiving container in a stable fashion, and the entire squeezer 100 may be rested or placed on top of the receiving container in a stable fashion just by using the first and second pressers 102 and 104 and the first and second handles 108 and 110. Alternatively, the first and second pressers 102 and 104 and the first and second handles 108 and 110 may support the entire squeezer 100 above the receiving container, in combination with the support 116 and/or the hinge 106 area that have substantially flat surfaces.

In some embodiments, for example as shown in FIGS. 1-4, the top of the first and second handles 108 and 110 may gradually slope down as they connect with the end gripping sections of the first and second handles 108 and 110 respectively. In other words, the top of the first handle 108 may have a slanting shape as it nears the end gripping section of the first handle 108, and the top of the second handle 110 may have a slanting shape as it nears the end gripping section of the second handle 110. These gradually sloping shapes of the first and second handles 108 and 110 may allow for better transfer of energy from the end gripping sections of the first and second handles 108 and 110 respectively, and may allow for better structural integrity between the first presser 102 and first handle 108 and between the second presser 104 and second handle 110.

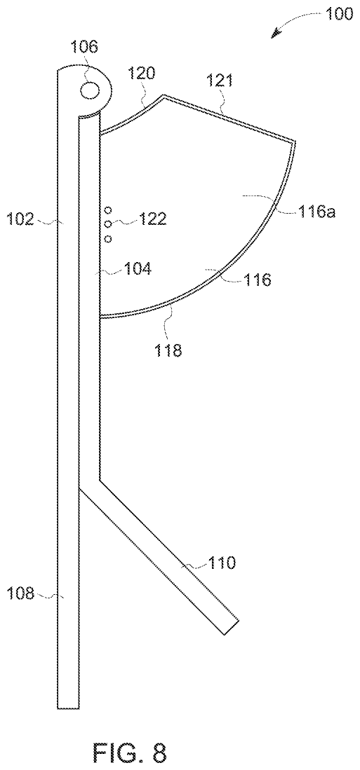

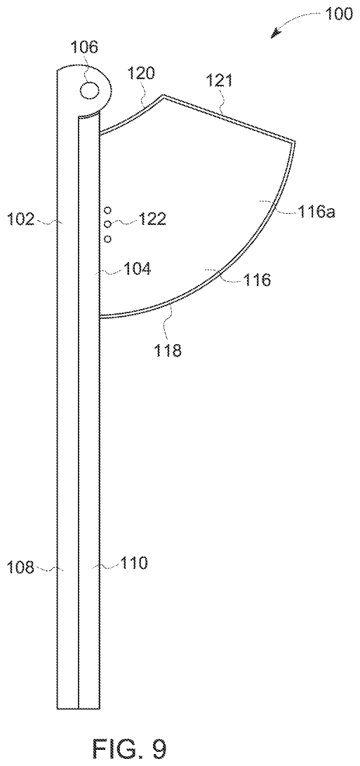

In some embodiments, one or more of the first and second handles 108 and 110 may have a bent or protruded shape. In some embodiments, the bent or protruded shape may enable the user to fully close the first and second pressers 102 and 104 (e.g., such that the pressing surfaces 102a and 104a of the first and second pressers 102 and 104 are pressed against each other) in a comfortable fashion (e.g., without the user's fingers being squeezed by the first and second handles 108 and 110 as the first and second pressers 102 and 104 are closed). For example, as shown in FIG. 7, the second handle 110 may have a bent or protruded shape such that the first and second handles 108 and 110 form an upside down U-shape when the first and second pressers 102 and 104 are fully closed. However, other bent or protruded shapes for one or more of the first and second handles 108 and 110 are possible. For example, as shown in FIG. 8, in some alternative embodiments, the second handle 110 may have a bent or protruded shape such that the first and second handles 108 and 110 form an upside down V-shape when the first and second pressers 102 and 104 are fully closed. Moreover, it is not necessary that one or more of the first and second handles 108 and 110 have a bent or protruded shape, and, in some alternative embodiments, as shown in FIG. 9, both of the first and second handles 108 and 110 may be straight.

In some embodiments, the first and second handles 108 and 110 may be substantially made of different materials (e.g., made of silicone, plastic and/or aluminum) compared to the first and second pressers 102 and 104, and attached to the first and second pressers 102 and 104, in order to make the squeezer 100 lighter, less expensive, and/or for a better grip. In some embodiments, the first and second handles 108 and 110 may have additional materials (e.g., plastic or silicone coverings) in order to make the squeezer 100 lighter, less expensive, and/or for a better grip. In some embodiments, the first and second handles 108 and 110 may have different grip area shapes. In some embodiments, the first and second handles 108 and 110 may have a locking mechanism capable of locking together the first and second handles 108 and 110 (e.g., for easier storage).

In some embodiments, the squeezer 100 may maximize the lever mechanism created by the first and second handles 108 and 110, the first and second pressers 102 and 104, and the hinge 106. In some embodiments, the squeezer 100 may use squeezing motions from the side instead of squeezing motions from the top or squeezing motions from the top and bottom. In some embodiments, the pressing surfaces 102a and 104a of the first and second pressers 102 and 104 of the squeezer 100 may squeeze the fruit or vegetable or nut horizontally (instead of vertically) when the first and second pressers 102 and 104 are moved from an open position to a closed position. In some embodiments, the user may use both hands to squeeze the vegetable or fruit or nut, by using one hand to operate first handle 108 and the other hand to operate second handle 110. In some embodiments, the horizontal squeezing motion may allow for use of arm strength to squeeze the fruit or vegetable instead of mainly relying on finger, hand and wrist strength. In some embodiments, the long distance of the handles from the hinge (e.g., the distance from the hinge to the end of each handle being greater than 8, 9, 10, or 11 inches) may also contribute to greater lever force. In some embodiments, the ability to easily use both hands to completely close the squeezer 100 and squeeze the food item (e.g., lemon, lime, orange, tomato, or walnut) may allow for use of arm strength instead of relying mainly on finger, hand and wrist strength. In some embodiments, the entire bottom surface of the squeezer 100 may be substantially flat.

In some embodiments, the squeezer 100 may be able to be rested on the receiving container (e.g., kitchen bowl, mixing bowl, salad bowl, cooking pot, glass, or mug) while the user squeezes the fruit or vegetable without leakage of juice to outside the container, allowing the user to exert less energy when operating the squeezer 100. The ability to safely place or rest the squeezer 100 on a container may be due to the squeezer 100, as a whole, having a flat surface or substantially a flat surface at the bottom that makes it easy to place the squeezer 100 on top of containers in a stable fashion. It may also be due to the squeezer 100 having a total length greater than 4 inches (10.16 cm) (e.g., greater than 4 inches (10.16 cm), 6 inches (15.24 cm), or 8 inches (20.32 cm)) from the hinge 106 to the end of the first handle 108 and/or having a total length greater than 4 inches (10.16 cm) (e.g., greater than 4 inches (10.16 cm), 6 inches (15.24 cm), or 8 inches (20.32 cm)) from the hinge 106 to the end of the second handle 110. It may also be due to the squeezer 100 being light enough not to damage a typical container such as made of glass, plastic, ceramic, or stainless steel, or fall off such container, when rested on top of the container. It may also be due to the squeezer 100 having one or more components having flat or close to flat bottom surfaces, that can be rested on top of a separate container, including for example the first handle 108, the second handle 110, the first presser 102, the second presser 104, the hinge 106 area, and/or the support 116. For example, the user can use 3 resting points such as the first and second handles 108 and 110 and the hinge 106 area, or the first and second handles 108 and 110 and the support 116, to rest the squeezer 100 on top of a container. It may also be due to the strainer section of support surface 106a being located at enough distance from the hinge 106 to allow the extraction to be extracted safely into the container and not outside the container. In other words, when the squeezer 100 is rested or placed on top of a container and the user squeezes the fruit or vegetable, the juice may flow through the one or more holes 122 (e.g., strainer holes or perforations) and safely into the container, due to the position of the one or more holes 122. The ability to rest the squeezer 100 directly on top of a receiving container may allow for less hassle, time, and/or energy for the user in getting the extraction to the intended destination such as directly into a salad bowl. The user may exert less energy and prevent strain on the fingers, hands, wrists, and/or arms when squeezing the fruit or vegetable or nut, since the user does not have to hold up the squeezer 100 while in operation. The squeezer 100 may also be able to be rested on top of a separate container while not in use due to the characteristics mentioned above.

In some embodiments in which the squeezer 100 has support 116 extending from the bottom of the first presser 102 and the support 116 has walls on all sides, the second presser 104 may have slits or slots (e.g., openings 124a and 124b) as shown in FIGS. 1-3 that allow one or more walls to pass through as the first and second handles 108 and 110 are pivotally moved. The support walls may be integrally formed with the support surface 116a. The openings (e.g., openings 124a and 124b) in second presser 104 may allow the second presser 104 to move directly above the support surface 116a. Such openings (e.g., openings 124a and 124b) may also allow for the support surface 116a with walls to be located directly below the first and second pressers 102 and 104 as shown in FIGS. 1-2, which in turn may allow the placement of the fruit or vegetable or nut in the optimal position at the bottom of first and second pressers 102 and 104, fully in between pressing surfaces 102a and 104a to apply the maximum force when squeezing. In this case, the fruit or vegetable or nut may be completely squeezed from top to bottom while the extraction and any shells are being fully captured by the support surface 116a and the walls that completely surround support 116. For example, any extraction (e.g., juice, pulp, or seeds) that may drip from the first and second pressers 102 and 104 may also be fully captured by the support surface 116a and the integrally formed walls of support 116, due to the support walls being higher than the very bottom levels of the first and second pressers 102 and 104. Since the openings (e.g., openings 124a and 124b) in the second presser 104 allow the support walls to pass through the openings when the first and second pressers 102 and 104 are moved, the support 116 can be surrounded by walls on all sides, providing maximum prevention of spillage of juice, pulp, seeds, nut meat and/or shells to undesired places. Another advantage of the openings (e.g., openings 124a and 124b) in the second presser 104 may be that they enable the entire bottom of the squeezer 100 to be flat or essentially flat, which makes it easy to rest or place the squeezer 100 on top of a separate receiving container. This is because the openings in the second presser (e.g., openings 124a and 124b) that accommodate the support walls may enable the support surface 116a to be even or substantially even with the rest of the bottom surfaces of the squeezer 100. For example, if the support surface 116a, the bottom surfaces of the pressers 102 and 104, the bottom surfaces of the handles 108 and 110, and the bottom surface of the area of the hinge 106 are flat or substantially flat, the overall bottom surface of the entire squeezer 100 may be flat.

In some embodiments, the squeezer 100 may be used with, for example and without limitation, a citrus fruit. In some embodiments, the citrus fruit may be cut in half or into further pieces and placed on the support surface 116a of the support 116. In some embodiments, the citrus fruit may be placed with the cut surface facing down or sideways. In some embodiments, the citrus fruit may be placed on the support surface 116a close to the pivoting hinge 106 (when viewed from above), which allows for the pressing surfaces 102a and 104a of the first and second pressers 102 and 104 to apply the maximum amount of force to the citrus fruit when the first and second handles 108 and 110 are used to move the first and second pressers 102 and 104 from an open position to a closed position. In some embodiments, the first and second handles 108 and 110 may be closed together from the side, which may cause the pressing surfaces 102a and 104a of the first and second pressers 102 and 104 to squeeze the citrus fruit from the side. In some embodiments, the squeezer 100 may be constructed in a way that causes the extracted juice and seeds to flow down towards the intended direction, which may be convenient when extracting the juice directly into a separate container (e.g., salad bowl, mixing bowl, cooking pot, or glass). For example for a citrus, the half citrus may be placed with the cut surface facing downward on the support surface 116a above the strainer section. This may naturally allow the extraction to flow downward in the intended direction, while maximizing the amount extracted from the citrus. In addition, in some embodiments, the citrus may be surrounded by walls on all sides, which may allow any other juice, which may be minor, to be caught by the walls and kept within the walls. In some embodiments, the one or more holes 122, which may be located in the support surface 116a below the citrus fruit when it is squeezed, may strain extracted liquid.

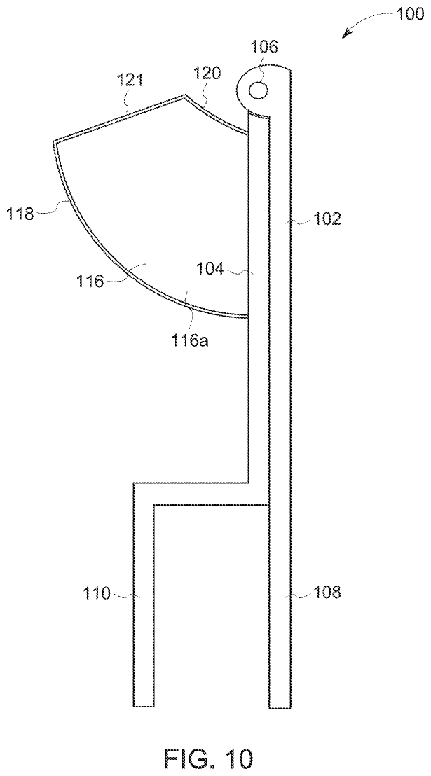

Although the support 116 is illustrated in FIGS. 1, 2, and 5-9 with one or more holes 122 that form a strainer section of the support surface 116a of the support 116, the one or more holes 122 (and strainer section formed thereby) are not necessary. For example, in some alternative embodiments, as shown in FIG. 10, the support 116 may include one or more walls (e.g., exterior wall 118, interior wall 120, end wall 121, and/or pressing surface 102a functioning as a wall) but no holes. In these embodiments, the support 116 may act as a container for juice, pulp, and/or seeds extracted from the fruit or vegetable, and in the case of nuts, a receiving container for the extracted nut meat and shells.

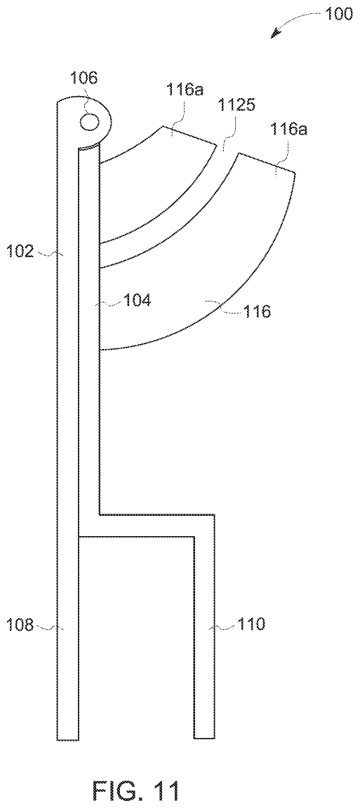

For another example, in some alternative embodiments, as shown in FIG. 11, the support 116 may not include walls 118, 120, and 121, and may not include holes. In these embodiments, the support 116 may act as a holder for the fruit or vegetable or nut as it is squeezed by the pressing surfaces 102a and 104a of the first and second pressers 102 and 104. In some holder embodiments, as shown in FIG. 11, the support surface 116a of the support 116 may include first and second surfaces that protrude from the first presser 102 and are separated by a gap 1125, which may allow extracted juice to flow through the support 116. In some alternative holder embodiments, the support 116 may instead be a net holder (e.g., a net hanging from the first and second pressers 102 and 104), and the net may have holes sized to strain juice extracted from the fruit or vegetable. In some alternative holder embodiments, the support 116 may be a protruding bar or spike holder (e.g., one or more bars or spikes extending from the pressing surface 102a or 104a) in which the fruit or vegetable may be pierced by the bar(s) or spike(s) to keep it in place. In some embodiments, the presser that does not contain the support 116 may have openings to allow the entire support structure (e.g., support surface and any walls or bars or spikes) to pass through as the pressers 102 and 104 are moved.

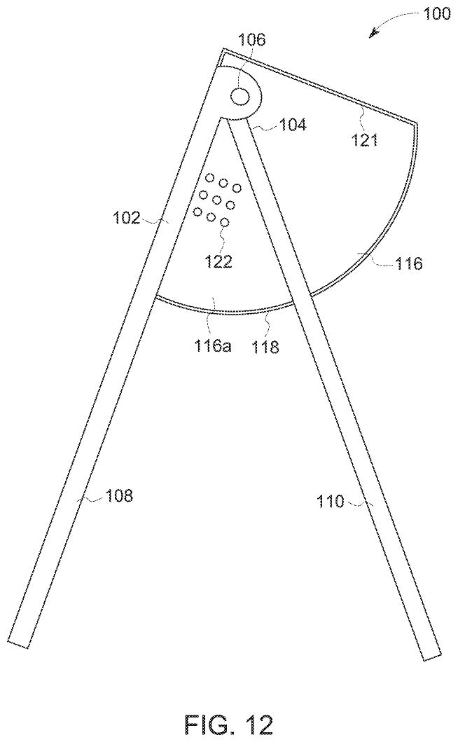

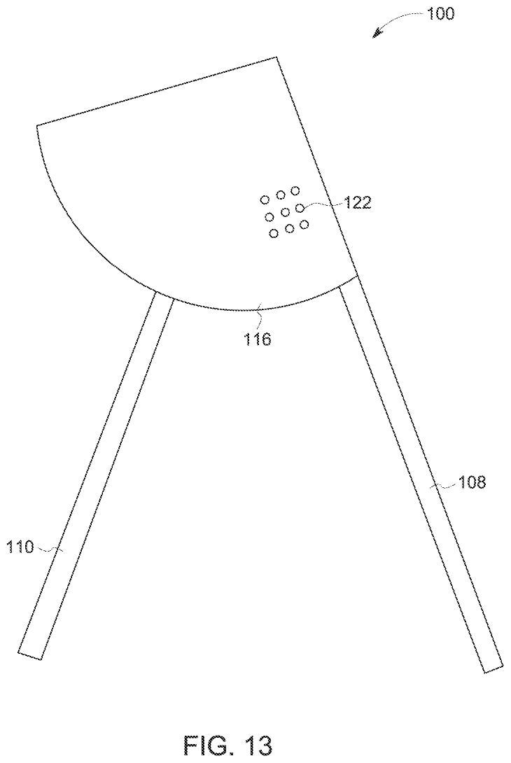

For another example, in some alternative embodiments, as shown in FIGS. 12 and 13, the support 116 may have exterior wall 118 and end wall 121 but not include an interior wall (e.g., interior wall 120 of FIGS. 1, 2, 5, and 7). In these embodiments, the end wall 121 may extend to (a) the pressing surface 102a of the first presser 102 or (b) a wall of the support 116 that is parallel to and extends from the first presser 102 in which case the support surface 116a may extend below the hinge 106.

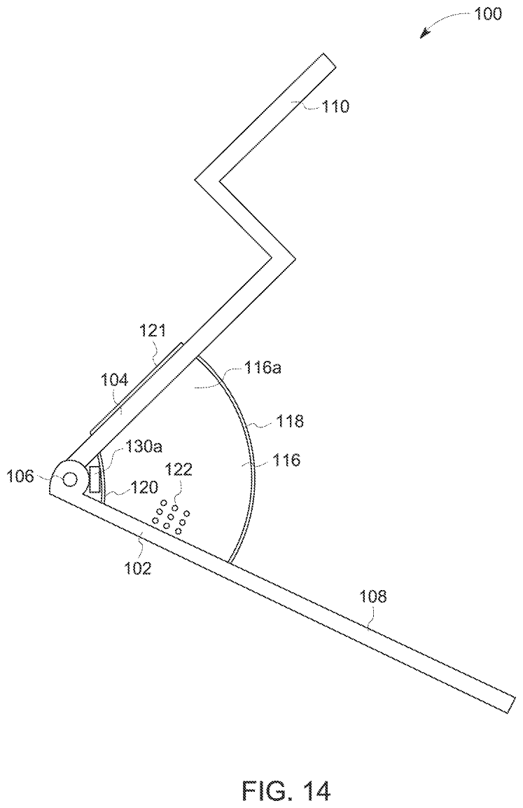

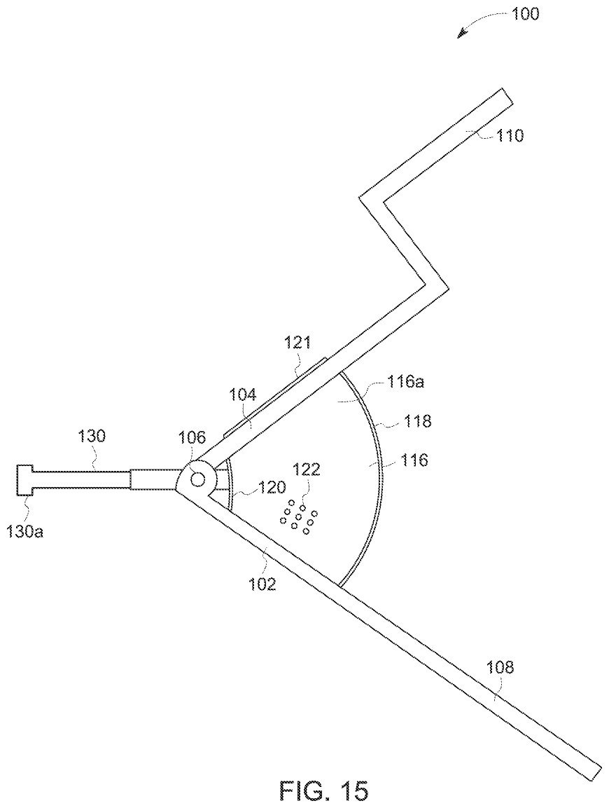

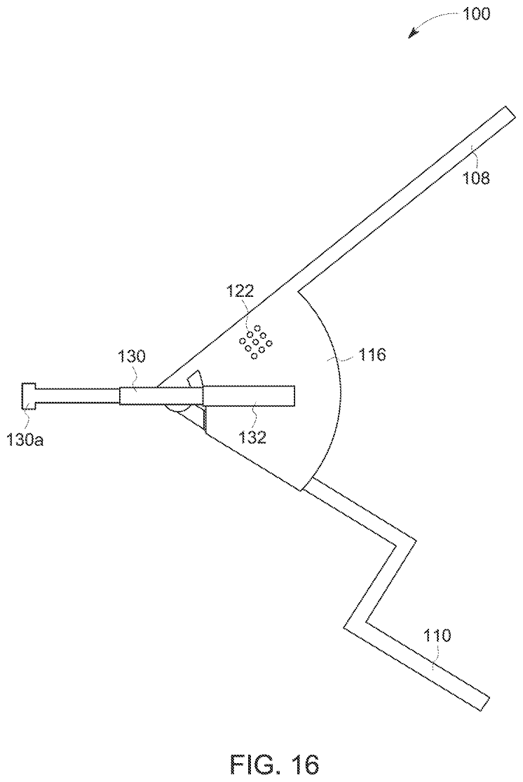

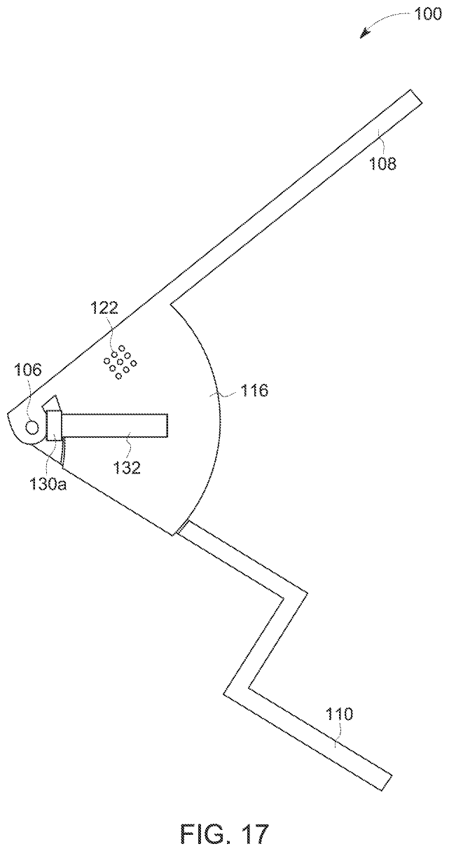

In some embodiments, as shown in FIGS. 14-17, the squeezer 100 may also have a squeezer holder bar 130 that supports the squeezer 100 as it is rested or placed on top of a separate container. While the squeezer 100 may be able to be rested or placed on top of a receiving container without the use of this holder bar 130, if the user wishes to place the support 116 (e.g., a support that contains a strainer section) closer to the center of the receiving container or in any other position, this squeezer holder bar 130 may be helpful in positioning the squeezer 100 for that purpose. In some embodiments, the squeezer holder bar 130 may be retractable from a squeezer holder bar container 132 which may be attached to the bottom surface of the support 116 as illustrated in FIGS. 16 and 17. The user may be able to pull out the squeezer holder bar 130 from the squeezer holder bar container 132 using the squeezer holder bar handle 130a which may be attached to the top of the squeezer holder bar 130 or extend from the squeezer holder bar 130. As shown in FIG. 17, the user may push the retractable squeezer holder bar 130 into the squeezer holder bar container 132 when not using the squeezer holder bar 130. The squeezer holder bar 130 and/or the squeezer holder bar container 132 may be attached to or extend from any part of the squeezer 100 including the support 116, the area of the hinge 106, the end of the first presser 102 and/or the end of the second presser 104. There may be more than one squeezer holder bar 130 contained in the squeezer 100. The squeezer holder bar 130 may be made of any material including stainless steel, aluminum, silicone, plastic, or rubber.

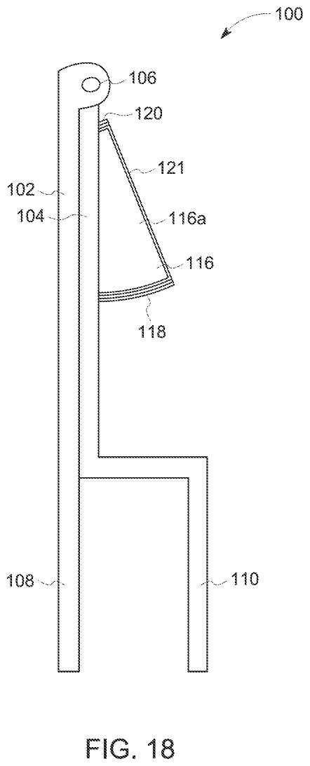

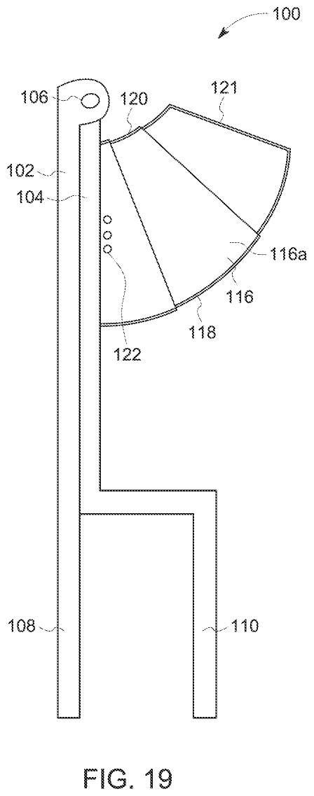

In some alternative embodiments, as shown in FIGS. 18 and 19, the support 116 of the squeezer 100 may be collapsible or retractable so that the squeezer 100 will take up less space while being stored or transported. In some embodiments, the support 116 may be broken up into 2 or more sections (e.g., 2, 3, or 4 sections), so that it can be collapsed from an open position as shown in FIG. 19 to a closed position as shown in FIG. 18 by collapsing one or more sections. Such collapsible or retractable support may be made of hard, soft, or flexible material including stainless steel, aluminum, plastic, rubber, or silicone.

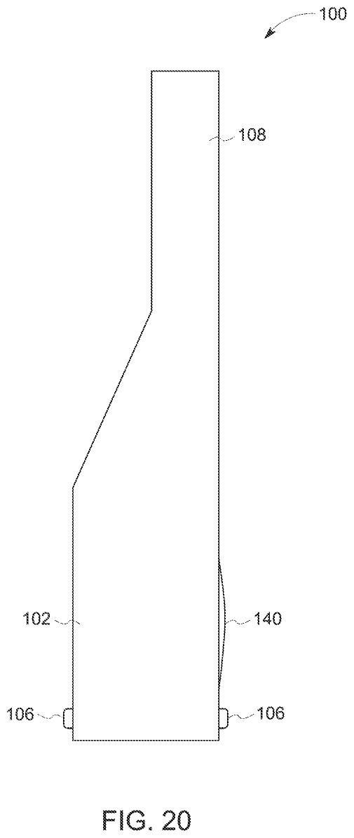

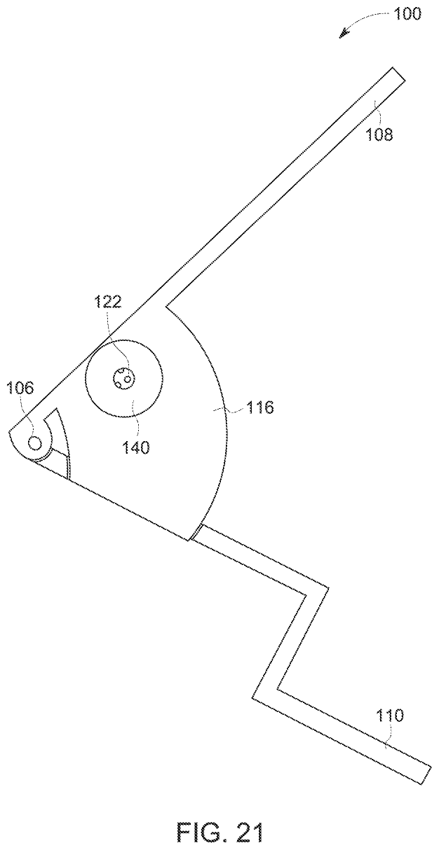

In some embodiments, as shown in FIGS. 20 and 21, the squeezer 100 may also have a funnel member 140 on the bottom side of the support 116 below the strainer section where the one or more holes 122 are located acting as straining perforations. The funnel member 140 may be useful for the purpose of funneling the juice to a smaller targeted area in the receiving container. The funnel member 140 may also be particularly useful when squeezing juice into smaller containers such as drinking glasses and mugs.

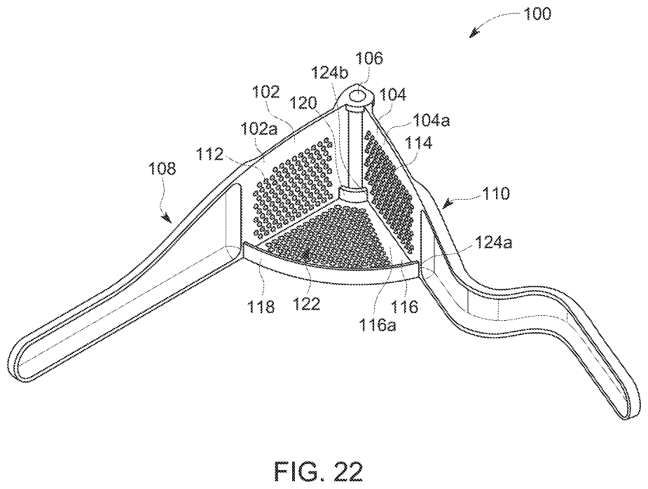

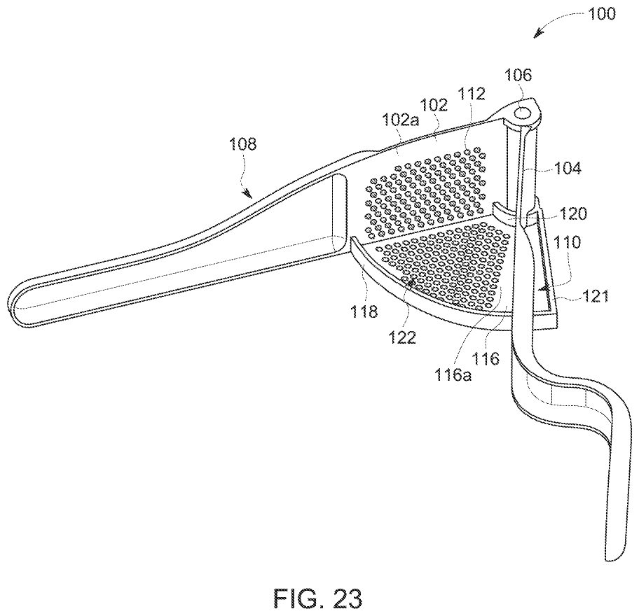

In some embodiments, as shown in FIGS. 22 and 23, the handles 108 and 110 may be hollow or may include various grooves, channels, cut outs, and the like. In some embodiments, as shown in FIGS. 22 and 23, the strainer section comprised of holes 122 of the support surface 116a of the support 116 may extend throughout most of the support surface 116a.

In some embodiments, an additional part may be attached to the squeezer 100 for the purpose of locking and holding the first and second pressers 102 and 104 together and/or the first and second handles 108 and 110 together.

In some embodiments, the total length of the first presser 102 and first handle 108 (e.g., from the hinge 106 to the end of the first handle 108) may be greater than 4 inches (10.16 cm), and/or the total length of the second presser 104 and second handle 110 (e.g., from the hinge 106 to the end of the second handle 110) may be greater than 4 inches (10.16 cm). In some embodiments, the total length of the first presser 102 and first handle 108 (e.g., from the hinge 106 to the end of the first handle 108) may be greater than 6 inches (15.24 cm), and/or the total length of the second presser 104 and second handle 110 (e.g., from the hinge 106 to the end of the second handle 110) may be greater than 6 inches (15.24 cm). In some embodiments, the total length of the first presser 102 and first handle 108 (e.g., from the hinge 106 to the end of the first handle 108) may be greater than 8 inches (20.32 cm), and/or the total length of the second presser 104 and second handle 110 (e.g., from the hinge 106 to the end of the second handle 110) may be greater than 8 inches (20.32 cm). In some embodiments, the total length of the first presser 102 and first handle 108 may include the lengths of both regardless of whether the first handle 108 is formed integrally with or separately from the first presser 102, and/or the total length of the second presser 104 and second handle 110 may include the lengths of both regardless of whether the second handle 110 is formed integrally with or separately from the second presser 104.

In some embodiments, the total length of any side of the squeezer 100 (e.g., a first side including the first presser 102, first handle 108, and/or any other component on the first side and/or a second side including the second presser 104, second handle 110, and/or any other component on the second side) as measured from the hinge 106 may be greater than 4 inches (10.16 cm). In some embodiments, the total length of any side of the squeezer 100 (e.g., a first side including the first presser 102, first handle 108, and/or any other component on the first side and/or a second side including the second presser 104, second handle 110, and/or any other component on the second side) as measured from the hinge 106 may be greater than 6 inches (15.24 cm). In some embodiments, the total length of any side of the squeezer 100 (e.g., a first side including the first presser 102, first handle 108, and/or any other component on the first side and/or a second side including the second presser 104, second handle 110, and/or any other component on the second side) as measured from the hinge 106 may be greater than 8 inches (20.32 cm).

In some embodiments, the height of the first presser 102 (e.g., from the bottom to the top of first presser 102) may be more than 0.5 inch (1.27 cm), and/or the height of the second presser 104 (e.g., from the bottom to the top of second presser 104) may be more than 0.5 inch (1.27 cm). In some embodiments, the height of the first presser 102 (e.g., from the bottom to the top of first presser 102) may be more than 1 inch (2.54 cm), and/or the height of the second presser 104 (e.g., from the bottom to the top of second presser 104) may be more than 1 inch (2.54 cm). In some embodiments, the height of the first presser 102 (e.g., from the bottom to the top of first presser 102) may be more than 1.5 inch (3.81 cm), and/or the height of the second presser 104 (e.g., from the bottom to the top of second presser 104) may be more than 1.5 inch (3.81 cm).

In some embodiments, the thickness of any part of the squeezer 100 may be 7 mm (0.7 cm) or less. In other words, the material thickness of any part of the squeezer 100 may be 7 mm (0.7 cm) or less, which may be advantageous in terms of weight, ease of use, and material cost.

In some embodiments, the thickness of any part of the squeezer 100 may be 10 mm (1 cm) or less. In other words, the material thickness of any part of the squeezer 100 may be 10 mm (1 cm) or less, which may be advantageous in terms of weight, ease of use, and material cost.

Embodiments of the present invention have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention. For example, the squeezer 100 can be larger or smaller. For another example, in various embodiments, the dimensions of each component of the squeezer 100 can be different (e.g., for larger squeezing surface areas and/or longer handles). For yet another example, the various embodiments of the squeezer 100 may alternatively be constructed in a flipped or mirrored configuration.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A side-squeezing squeezer comprising:
a hinge;
a first presser connected to the hinge;
a second presser connected to the hinge opposite of the first presser; and
a support positioned between the first presser and the second presser and configured to hold a foodstuff in place;
wherein the first and second pressers are configured to squeeze the foodstuff using lever action from the side.

2. The squeezer of claim 1, further comprising:
a first handle extending from the first presser; and
a second handle extending from the second presser.

3. The squeezer of claim 2 wherein at least one of the first handle and the second handle is hollow.

4. The squeezer of claim 1, wherein the support includes a support surface that is configured to support the foodstuff.

5. The squeezer of claim 1, wherein the support includes one or more holes configured to provide straining of liquid expelled from the foodstuff.

6. The squeezer of claim 1, wherein the support includes one or more walls extending around at least a portion of a periphery of the support.

7. The squeezer of claim 6, further comprising one or more openings extending through the second presser, the one or more openings configured to allow for a wall of the one or more walls to pass through the one or more openings when the squeezer is pressed together.

8. The squeezer of claim 1, wherein at least one of the first presser and the second presser includes a textured section.

9. The squeezer of claim 1, further comprising a bar attached to the support and configured to extend away from the hinge to provide support for the squeezer atop of a container.

10. The squeezer of claim 9 further comprising a bar container, wherein the bar is retractable and configured to be selectively extended from or retracted into the bar container.

11. The squeezer of claim 1, further comprising a funnel member attached to the support, the funnel member configured to direct expelled liquid from the foodstuff.

12. The squeezer of claim 1, further comprising a flat plane created along a surface of the hinge, a surface of the first presser, and a surface of the second presser; wherein the flat plane allows for the squeezer to rest flat on a surface or a container.

13. The squeezer of claim 1, wherein the support is collapsible.

14. The squeezer of claim 1 wherein at least one of the first presser and the second presser is a blade.

15. A side-squeezing squeezer comprising:
a hinge;
a first presser connected to the hinge;
a second presser connected to the hinge opposite of the first presser;
a support positioned between the first presser and the second presser and configured to hold a foodstuff in place, the support including one or more holes configured to provide straining of liquid expelled from the foodstuff;
a first handle extending from the first presser; and
a second handle extending from the second presser;
wherein the first and second pressers are configured to squeeze the foodstuff using lever action from the side.

16. The squeezer of claim 15, wherein the support includes one or more walls extending around at least a portion of a periphery of the support; and wherein the second presser comprises one or more openings extending therethrough that is configured to allow for a wall of the one or more walls to pass through the one or more openings when the squeezer is pressed together.

17. The squeezer of claim 15, wherein at least one of the first presser and the second presser includes a textured section.

18. The squeezer of claim 15, further comprising:
a bar container; and
a retractable bar attached to the support and configured to extend away from the hinge to provide support for the squeezer atop of a container and is further configured to be selectively extended from or retracted into the bar container.

19. The squeezer of claim 15, further comprising a flat plane created along a surface of the hinge, a surface of the first presser, and a surface of the second presser; wherein the flat plane allows for the squeezer to rest flat on a surface or a container.

20. A side-squeezing squeezer comprising:
a hinge;
a first presser connected to the hinge and including a textured section;
a second presser connected to the hinge opposite of the first presser and including:
a textured section; and
one or more openings extending therethrough;
a support positioned between the first presser and the second presser and configured to hold a foodstuff in place, the support including:
one or more holes configured to provide straining of liquid expelled from the foodstuff; and
one or more walls extending around at least a portion of a periphery of the support;
a first handle extending from the first presser; and
a second handle extending from the second presser;
wherein the first and second pressers are configured to squeeze the foodstuff using lever action from the side; and
wherein the one or more openings is configured to allow for a wall of the one or more walls to pass through the one or more openings when the squeezer is pressed together.
